(19) United States
(12) Patent Application Publication
(10) Pub. No.: US 2002/0113666 A1
(43) Pub. Date: Aug. 22, 2002

(54) Directional coupler directional coupling method

(76) Inventors: Masazumi Yamazaki, Yokohama-shi (JP); Fujio Sasaki, Yokohama-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/069,641

(22) PCT Filed: Jul. 3, 2001
(86) PCT No.: PCT/JP01/05740

(30) Foreign Application Priority Data
Jul. 4, 2000 (JP) 2000-202665

(51) Int. Cl. H01P 5/12

(52) U.S. Cl. 333/109

(57) ABSTRACT

Input port 101 is connected to output port 102 via open-circuited stub 107, first transmission line 105 and open-circuited stub 108. Coupling port 103 is connected to isolation port 104 via second transmission line 106 in electromagnetic coupling with first transmission line 105. Open-circuited stubs 107 and 108 have a stub length corresponding to ¼ wavelength in desired stop frequency. It is thereby possible to provide a directional coupler and directional coupling method enabling the miniaturization and harmonic spurious suppression effect with a low loss and with excellence even in microwave/millimeter wave band.

### TECHNICAL FILED

The present invention relates to a directional coupler and directional coupling method applicable to a strip line used in a radio communication apparatus such as a cellular telephone and radio data communication port used particularly in microwave/millimeter wave band.

### BACKGROUND ART

Generally in radio communication apparatuses, a directional coupler using a λ/4 strip line is used, and a multilayer directional coupler enabling miniaturization. For example, a directional coupler disclosed in Japanese Laid-Open Patent Publication HEI10-290108 is one to which the low-pass filter function is added. A laminate constructed by integrating a directional coupler, and a capacitor and shunt resonator composing a low-pass filter obtains a miniaturized shape and characteristics with a low loss as compared to a case of achieving the directional coupler and low-pass filter separately.

Due to widespread use of cellular telephones and demand for fast data communication, the carrier frequency in radio communications tends to be higher to a superhigh frequency band and to an extremely high frequency band providing rich frequency resources. A harmonic frequency band targeted for suppression by a low-pass filter has a frequency integer times as high as thus increased carrier frequency. In such a high frequency band, a size of a part is not negligible with respect to a wavelength, and a circuit tends to behave like a distributed circuit. Therefore, in conventional radio communication apparatuses, it is not possible to achieve required characteristics in capacitor and shunt resonator composing a low-pass filter, resulting in a problem that a desired suppression amount as a filter cannot be obtained.

### DISCLOSURE OF INVENTION

It is an object of the present invention to provide a directional coupler and directional coupling method enabling miniaturization and harmonic spurious suppression effect with a low loss and with excellence even in microwave/millimeter wave band.

This object is achieved by disposing stubs for radio-frequency spurious suppression at input and output sides of a first transmission line of a directional coupler, and using the stubs with susceptance and the first transmission line, performing impedance matching in carrier frequency between circuits connected to input and output ports.

### BRIEF DESCRIPTION OF DRAWINGS

FIG. 1 is a diagram illustrating an example of a configuration of a directional coupler according to a first embodiment of the present invention;

FIG. 2 is a diagram illustrating an equivalent circuit of the directional coupler in center frequency according to the first embodiment of the present invention;

FIG. 3 is a diagram illustrating characteristics of the directional coupler according to the first embodiment of the present invention;

FIG. 4 is a diagram illustrating an example of a configuration of a radio communication apparatus using the directional coupler according to the first embodiment of the present invention;

FIG. 5 is a diagram illustrating an example of a configuration of a directional coupler according to a second embodiment of the present invention;

FIG. 6 is a diagram illustrating an equivalent circuit of the directional coupler in center frequency according to the second embodiment of the present invention;

FIG. 7 is a diagram illustrating characteristics of the directional coupler according to the second embodiment of the present invention;

FIG. 8 is a diagram illustrating an example of a configuration of a radio communication apparatus using the directional coupler according to the second embodiment of the present invention;

FIG. 9 is a diagram illustrating an example of a configuration of a directional coupler according to a third embodiment of the present invention;

FIG. 10 is a diagram illustrating an equivalent circuit of the directional coupler in center frequency according to the third embodiment of the present invention;

FIG. 11 is a diagram illustrating characteristics of the directional coupler according to the third embodiment of the present invention;

FIG. 12 is a diagram illustrating an example of a configuration of a radio communication apparatus using the directional coupler according to the third embodiment of the present invention;

FIG. 13 is a diagram illustrating an example of a configuration of a directional coupler according to a fourth embodiment of the present invention;

FIG. 14 is a diagram illustrating an equivalent circuit of the directional coupler in center frequency according to the fourth embodiment of the present invention;

FIG. 15 is a diagram illustrating characteristics of the directional coupler according to the fourth embodiment of the present invention;

FIG. 16 is a diagram illustrating an example of a configuration of a radio communication apparatus using the directional coupler according to the fourth embodiment of the present invention;

FIG. 17 is a diagram illustrating an example of a configuration of a directional coupler according to a fifth embodiment of the present invention;

FIG. 18 is a diagram illustrating an equivalent circuit of the directional coupler in center frequency according to the fifth embodiment of the present invention;

FIG. 19 is a diagram illustrating characteristics of the directional coupler according to the fifth embodiment of the present invention;

FIG. 20 is a diagram illustrating an example of a configuration of a radio communication apparatus using the directional coupler according to the fifth embodiment of the present invention;

FIG. 21 is a diagram illustrating an example of a configuration of a directional coupler according to a sixth embodiment of the present invention;

FIG. 22 is a diagram illustrating an equivalent circuit of the directional coupler in center frequency according to the sixth embodiment of the present invention;

FIG. 23 is a diagram illustrating characteristics of the directional coupler according to the sixth embodiment of the present invention;

FIG. 24 is a diagram illustrating an example of a configuration of a radio communication apparatus using the directional coupler according to the sixth embodiment of the present invention;

FIG. 25 is a diagram illustrating an example of a configuration of a directional coupler according to a seventh embodiment of the present invention;

FIG. 26 is a diagram illustrating an equivalent circuit of the directional coupler in center frequency according to the seventh embodiment of the present invention;

FIG. 27 is a diagram illustrating characteristics of the directional coupler according to the seventh embodiment of the present invention;

FIG. 28 is a diagram illustrating an example of a configuration of a radio communication apparatus using the directional coupler according to the seventh embodiment of the present invention;

FIG. 29 is a diagram illustrating an example of a configuration of a directional coupler according to an eighth embodiment of the present invention;

FIG. 30 is a diagram illustrating an equivalent circuit of the directional coupler in center frequency according to the eighth embodiment of the present invention;

FIG. 31 is a diagram illustrating characteristics of the directional coupler according to the eighth embodiment of the present invention;

FIG. 32 is a diagram illustrating an example of a configuration of a radio communication apparatus using the directional coupler according to the eighth embodiment of the present invention;

FIG. 33 is a diagram illustrating an example of a configuration of a directional coupler according to a ninth embodiment of the present invention;

FIG. 34 is a diagram illustrating an equivalent circuit of the directional coupler in center frequency according to the ninth embodiment of the present invention;

FIG. 35 is a diagram illustrating characteristics of the directional coupler according to the eighth embodiment of the present invention; and

FIG. 36 is a diagram illustrating an example of a configuration of a radio communication apparatus using the directional coupler according to the ninth embodiment of the present invention.

### BEST MODE FOR CARRYING OUT THE INVENTION

The present invention is to achieve the miniaturization and harmonic spurious suppression effect with a low loss and with excellence even in microwave/millimeter wave band, by disposing stubs for radio-frequency spurious suppression at input and output sides of a first transmission line of a directional coupler, and using the stubs with susceptance and the first transmission line, performing impedance matching in carrier frequency between circuits connected to input and output ports. In addition, a stub is a kind of line loaded in a signal line and has three parameters, i.e., electric length, characteristic impedance and port condition (open-circuited/short-circuited). The electric length is a parameter determined by length of the stub, and the characteristic impedance is a parameter determined by width of the stub.

Embodiments of the present invention will be described below with reference to accompanying drawings.

(First Embodiment)

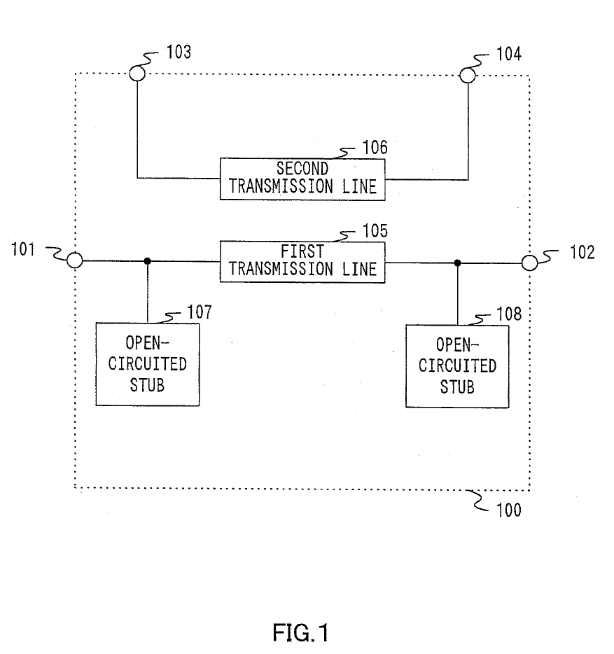

FIG. 1 is a diagram illustrating an example of a configuration of a directional coupler according to the first embodiment of the present invention, where the directional coupler is applied to one for monitoring transmit power.

Directional coupler 100 is primarily composed of input port 101, output port 102, coupling port 103, isolation port 104, first transmission line 105, second transmission line 106, and open-circuited stubs 107 and 108.

Input port 101 is connected to output port 102 via open-circuited stub 107, first transmission line 105 and open-circuited stub 108. Coupling port 103 is connected to isolation port 104 via second transmission line 106 in electromagnetic coupling with first transmission line 105.

Open-circuited stubs 107 and 108 have the same characteristics, and have a stub length corresponding to ¼ wavelength in desired stop frequency fs11. It is assumed in the following description that the characteristic impedance of the directional coupler composed of first transmission line 105 and second transmission line 106 is the same as the impedance of an external circuit.

The following description is given of achieving unnecessary signal suppression in desired stop frequency. Susceptance Bos(f) of an open-circuited stub becomes infinite (Bos(fsos)=infinite) in frequency f=fsos such that an electric length of the stub corresponds to ¼ wavelength. Accordingly, in frequency of fsos, impedance Zos obtained after inserting the open-circuited stub is not dependent on impedance Zip at a stub inserting point, and is expressed by following equation (1), and the circuit is short-circuited.

Zos(fsos)=1/{1/Zip+jBos(fsos)}=0Ω (1)

Accordingly, in the configuration illustrated in FIG. 1, in fs11, open-circuited stubs 107 and 108 develop a short-circuit in first transmission line 105, enabling the suppression of unnecessary signal in stop frequency fs11.

A case will be described next of matching impedance of external circuits (not shown) connected to input and output ports of directional coupler 100 in center frequency. In FIG. 1, first transmission line 105 and open-circuited stubs 107 and 108 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

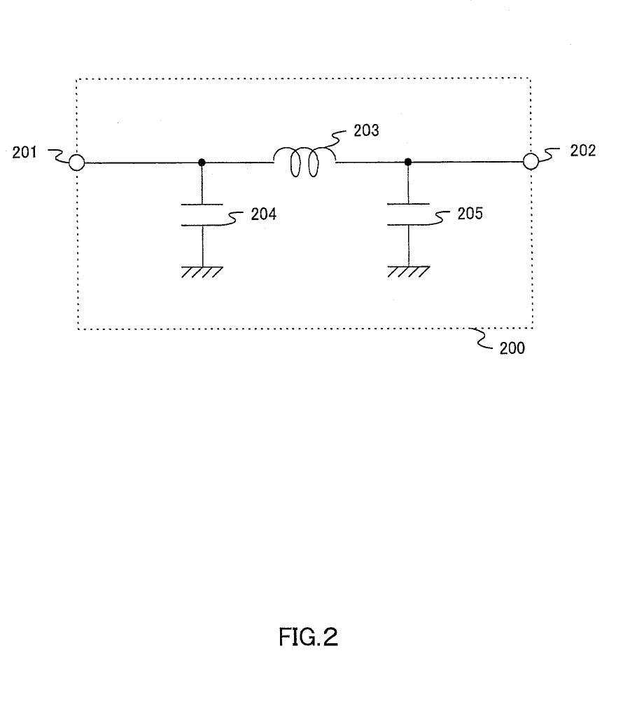

FIG. 2 illustrates matching circuit 200 obtained by approximating elements connected between input port 101 and output port 102 in directional coupler 100 in FIG. 1 by lumped-circuit elements in center frequency fo. In FIG. 2, input port 201 corresponds to input port 101 in FIG. 1, output port 202 corresponds to output port 102 in FIG. 1, inductor 203 corresponds to first transmission line 105 in FIG. 1, capacitor 204 corresponds to open-circuited stub 107 in FIG. 1, and capacitor 205 corresponds to open-circuited stub 108 in FIG. 1. Herein, since matching circuit 200 has the same configuration as that of a π-section LC matching circuit, the circuit 200 is capable of acquiring the matching between external circuits connected to input port 201 and output port 202, and as a result, is capable of decreasing a mismatching loss and of achieving low-loss characteristics.

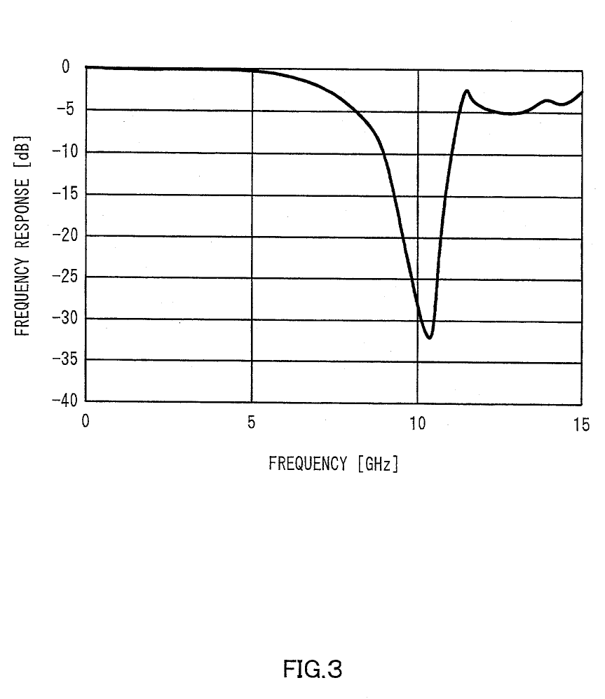

FIG. 3 illustrates pass characteristic of a directional coupler designed with cut-off frequencies fo=5 GHz and fs11=10 GHz and coupling coefficient=17 dB. In addition, the directional coupler is constructed on an alumina substrate with a thickness of 0.635 mm and dielectric constant of 10.

A loss between input port 101 and output port 102 in center frequency fo was 0.25 dB, among which a coupling loss was 0.09 dB and ohmic, dielectric, and radiated loss was 0.16 dB. A conventional directional coupler has a loss of 0.2 dB (including the coupling loss), and a loss of a filter is about 0.2 dB. Therefore, as compared to the conventional coupler, directional coupler 100 of the first embodiment improves the frequency response by about 0.15 dB, and obtains a suppression amount more than 30 dB in fs11 (10 GHz: corresponding to a double-frequency).

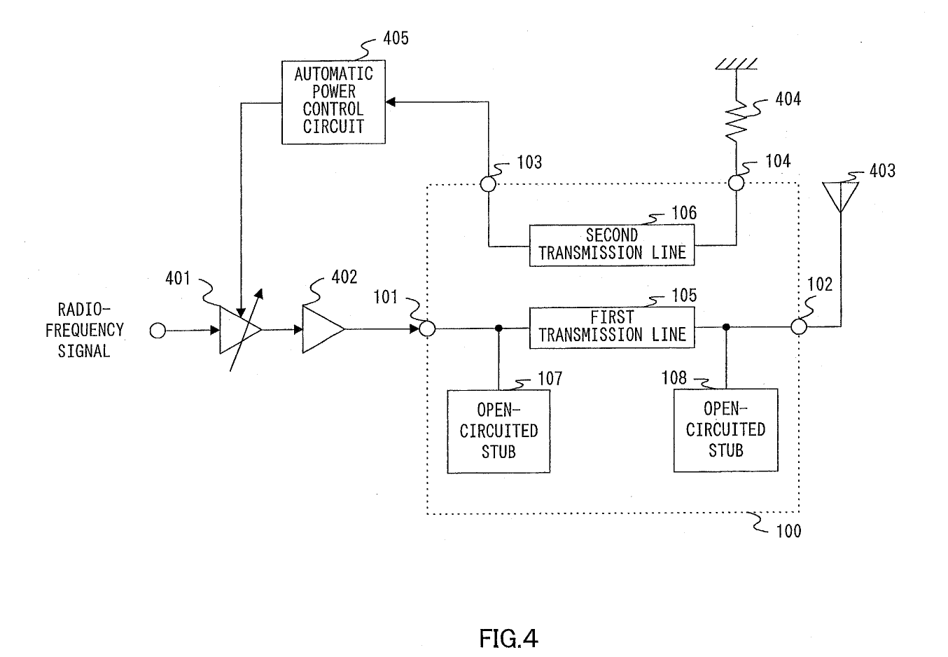

FIG. 4 is a specific example of a configuration of a radio communication apparatus applying the directional coupler according to the first embodiment of the present invention. In addition, in FIG. 4 since the configuration of directional coupler 100 is the same as in FIG. 1, the same reference numerals as in FIG. 1 are assigned to omit specific description thereof. In FIG. 4, a radio-frequency signal input to variable gain amplifier 401 is transmitted from antenna 403 via power amplifier 404 and directional coupler 100. Resistance 400 is an absorbing resistance for preventing coupling port 103 from being induced by part of a reflected signal due to mismatching of antennas or the like. Automatic power control circuit 405 monitors part of a transmit output fetched from directional coupler 100, and controls a gain of variable gain amplifier 401 so that the transmit output remains within predetermined limits.

By thus adding the function of a low-pass filter for canceling harmonic spurious to a directional coupler, it is possible to obtain the miniaturization and low-loss characteristics as compared to a case of achieving the directional coupler and low-pass filter separately. Further, the directional coupler with the circuit configuration as illustrated in FIG. 1 enables both the suppression characteristics in stop frequency and low-loss characteristics in center frequency to be obtained, and further enables a miniaturized directional coupler to be achieved.

(Second Embodiment)

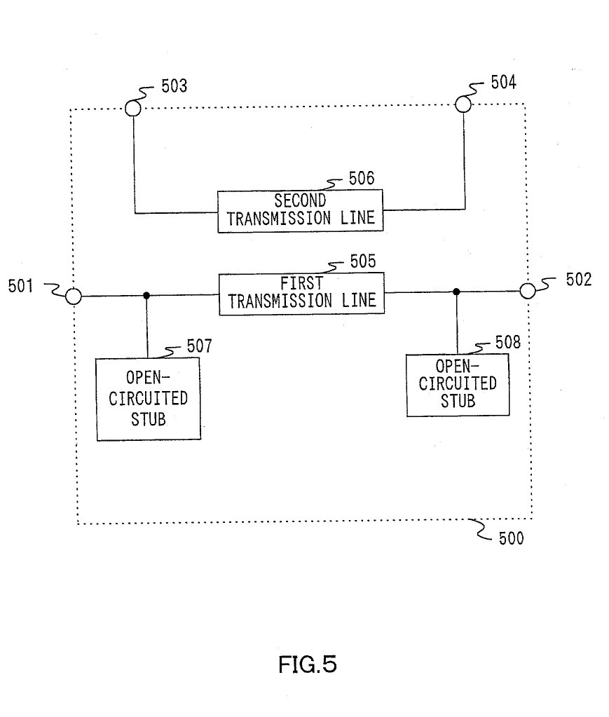

The second embodiment of the present invention will be described below with reference to FIGS. 5 to 8. FIG. 5 is a diagram illustrating an example of a configuration of a directional coupler according to the second embodiment of the present invention, where the directional coupler is applied to one for monitoring transmit power.

Directional coupler 500 is primarily composed of input port 501, output port 502, coupling port 503, isolation port 504, first transmission line 505, second transmission line 506, and open-circuited stubs 507 and 508. Input port 501 is connected to output port 502 via open-circuited stub 507, first transmission line 505 and open-circuited stub 508. Coupling port 503 is connected to isolation port 504 via second transmission line 506 in electromagnetic coupling with first transmission line 505.

Open-circuited stubs 507 and 508 have a stub length corresponding to ¼ wavelength in two different cut-off frequencies, i.e., fs21 and fs22, respectively. It is assumed in the following description that the characteristic impedance of the directional coupler composed of first transmission line 505 and second transmission line 506 is the same as the impedance of an external circuit.

The following description is given of achieving unnecessary signal suppression in desired stop frequency. In the configuration illustrated in FIG. 5, according to previously mentioned equation (1), since first transmission line 505 is short-circuited in stop frequency fs21 by open-circuited stub 507 and in stop frequency fs22 by open-circuited stub 508, it is possible to suppress unnecessary signals in two different cut-off frequencies, i.e., fs21 and fs22.

A case will be described next of matching impedance of external circuits (not shown) connected to input and output ports of directional coupler 500 in center frequency. First transmission line 505 and open-circuited stubs 507 and 508 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy, exclusively for a single frequency.

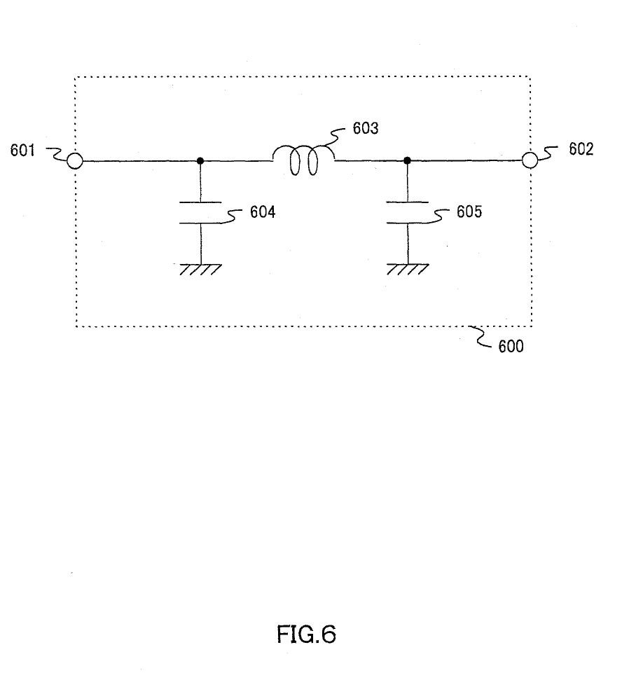

FIG. 6 illustrates matching circuit 600 obtained by approximating elements connected between input port 501 and output port 502 in directional coupler 500 in FIG. 5 by lumped-circuit elements in center frequency fo. In FIG. 6, input port 601 corresponds to input port 501 in FIG. 5, output port 602 corresponds to output port 502 in FIG. 5, inductor 603 corresponds to first transmission line 505 in FIG. 5, and capacitor 604 corresponds to open-circuited stub 507 in FIG. 5. Herein, since matching circuit 600 has the same configuration as that of a π-section LC matching circuit, the circuit 600 is capable of acquiring the matching between external circuits connected to input port 601 and output port 602, and as a result, is capable of decreasing a mismatching loss and of achieving low-loss characteristics.

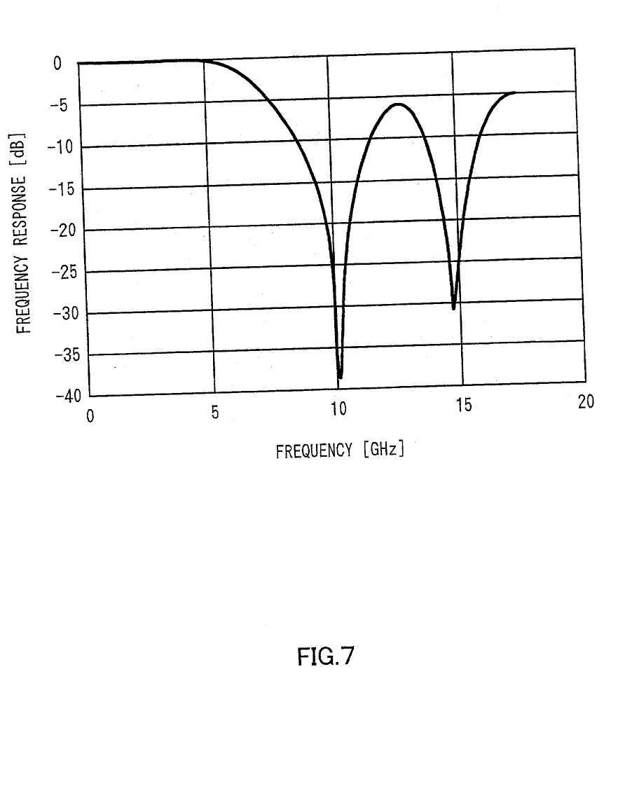

FIG. 7 is a diagram illustrating an example of characteristics of directional coupler 500, and more specifically illustrates a calculated response in the case where center frequency fo=5 GHz, cut-off frequencies fs21=10 GHz and fs22=15 GHz. Values obtained as a suppression amount in stop frequency are more than 35 dB in fs21 (10 GHz: corresponding to double-frequency) and more than 30 dB in fs22 (15 GHz: corresponding to triple-frequency).

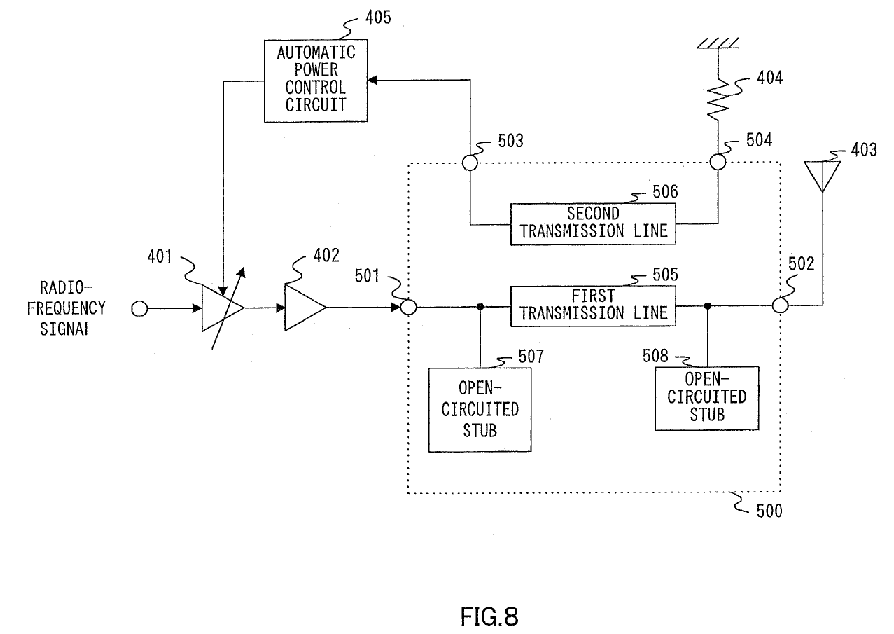

FIG. 8 is a specific example of a configuration of a radio communication apparatus applying the directional coupler according to the second embodiment of the present invention. The radio communication apparatus illustrated in FIG. 8 applies directional coupler 500 substituted for directional coupler 100 in the radio communication apparatus illustrated in FIG. 4. As compared to the radio communication apparatus illustrated in FIG. 4, in the radio communication apparatus illustrated in FIG. 8, since the function of canceling spurious in two different cut-off frequencies is added to the directional coupler, it is possible to obtain spurious suppression characteristics with more excellence.

(Third Embodiment)

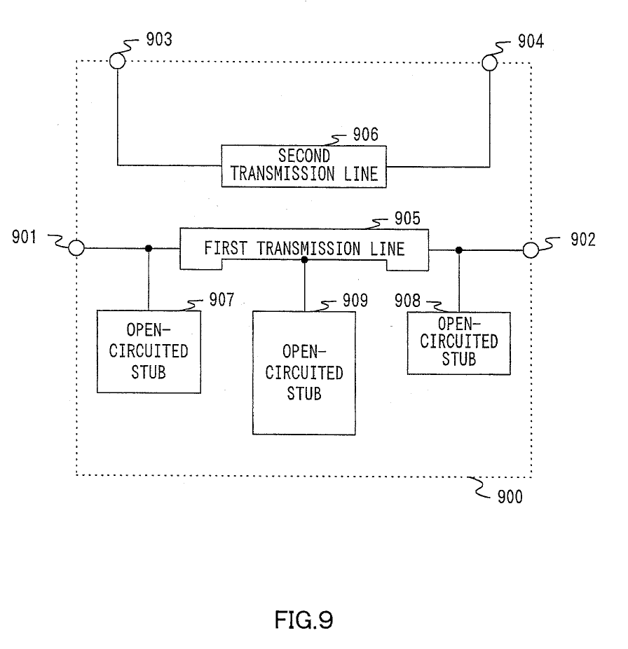

The third embodiment of the present invention will be described below with reference to FIGS. 9 to 12. FIG. 9 is a diagram illustrating an example of a configuration of a directional coupler according to the third embodiment of the present invention, where the directional coupler is applied to one for monitoring transmit power.

Directional coupler 900 is primarily composed of input port 901, output port 902, coupling port 903, isolation port 904, first transmission line 905, second transmission line 906, and open-circuited stubs 907, 908 and 909. Input port 901 is connected to output port 902 via open-circuited stub 907, first transmission line 905 and open-circuited stub 908. Open-circuited stub 909 is disposed on first transmission line 905. Coupling port 903 is connected to isolation port 904 via second transmission line 906 in electromagnetic coupling with first transmission line 905.

Open-circuited stubs 907, 908 and 909 have a stub length corresponding to ¼ wavelength in three different cut-off frequencies, i.e., fs31, fs32 and fs33, respectively. In addition, it is not necessary for first transmission line 905 and second transmission line 906 to have the same length.

The following description is given of achieving unnecessary signal suppression in desired stop frequency. In the configuration illustrated in FIG. 9, according to previously mentioned equation (1), since first transmission line 905 is short-circuited in stop frequency fs31 by open-circuited stub 907, in stop frequency fs32 by open-circuited stub 908, and in stop frequency fs33 by open-circuited stub 909, it is possible to suppress unnecessary signals in three different cut-off frequencies, i.e., fs31, fs32 and fs33.

A case will be described next of matching impedance of external circuits (not shown) connected to input and output ports of directional coupler 900 in center frequency. First transmission line 905 and open-circuited stubs 907, 908 and 909 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

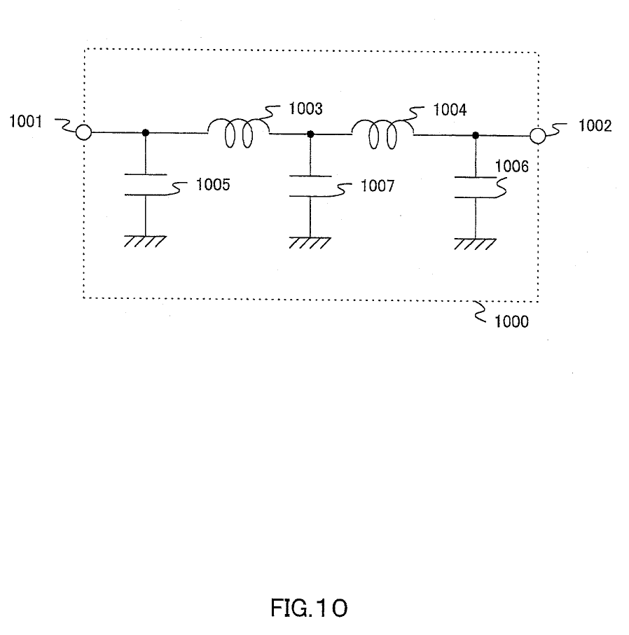

FIG. 10 illustrates matching circuit 1000 obtained by approximating elements connected between input port 901 and output port 902 in directional coupler 900 in FIG. 9 by lumped-circuit elements in center frequency fo. In FIG. 10, input port 1001 corresponds to input port 901 in FIG. 9, output port 1002 corresponds to output port 902 in FIG. 9, inductors 1003 and 1004 correspond to first transmission line 905 in FIG. 9, capacitor 1005 corresponds to open-circuited stub 907 in FIG. 9, capacitor 1006 corresponds to open-circuited stub 908 in FIG. 9, and capacitor 1007 corresponds to open-circuited stub 909 in FIG. 9. Herein, since matching circuit 1000 has the same configuration as that of an LC multistage π-section matching circuit, the circuit 1000 is capable of acquiring the matching between external circuits connected to input port 1001 and output port 1002, and as a result, is capable of decreasing a mismatching loss and of achieving low-loss characteristics.

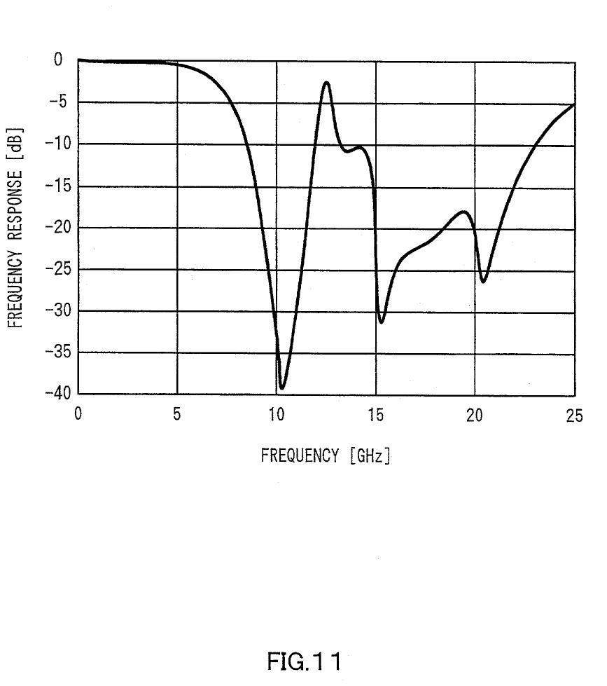

FIG. 11 is a diagram illustrating an example of characteristics of directional coupler 900, and more specifically illustrates a calculated response in the case where Zos31=57.7Ω, Zos32=41.4Ω, Zos33=50Ω, center frequency fo=5 GHz, cut-off frequencies fs31=15 GHz, fs32=20 GHz and fs33=10 GHz, characteristic impedance of first transmission line 905 is 50Ω, phase angle is 133.2°, and open-circuited stub 909 is disposed at a middle point on first transmission line 905. In addition, Zos31, Zos32 and Zos33 are impedance of lines composing open-circuited stubs 907, 908 and 909 in FIG. 9 respectively. Values obtained as a suppression amount in stop frequency are more than 20 dB in fs31 (15 GHz: corresponding to triple-frequency), more than 20 dB in fs32 (20 GHz: corresponding to four-time-frequency), and more than 30 dB in fs33 (10 GHz: corresponding to double-frequency).

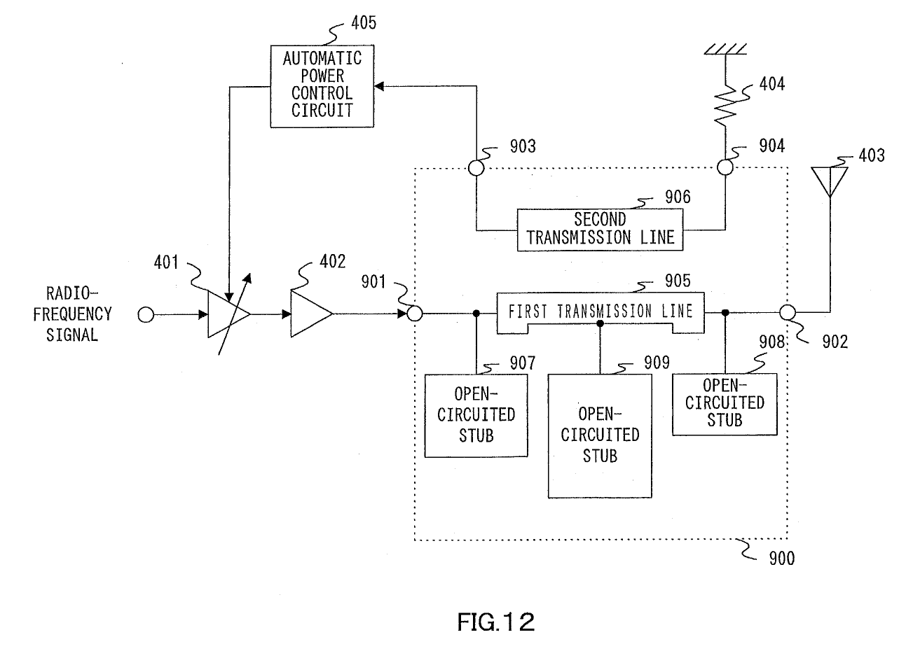

FIG. 12 is a specific example of a configuration of a radio communication apparatus applying the directional coupler according to the third embodiment of the present invention. The radio communication apparatus illustrated in FIG. 12 applies directional coupler 900 substituted for directional coupler 100 in the radio communication apparatus illustrated in FIG. 4. As compared to the radio communication apparatus illustrated in FIG. 4, in the radio communication apparatus illustrated in FIG. 12, since the function of canceling spurious in three different cut-off frequencies is added to directional coupler 900, it is possible to obtain spurious suppression characteristics with more excellence.

(Fourth Embodiment)

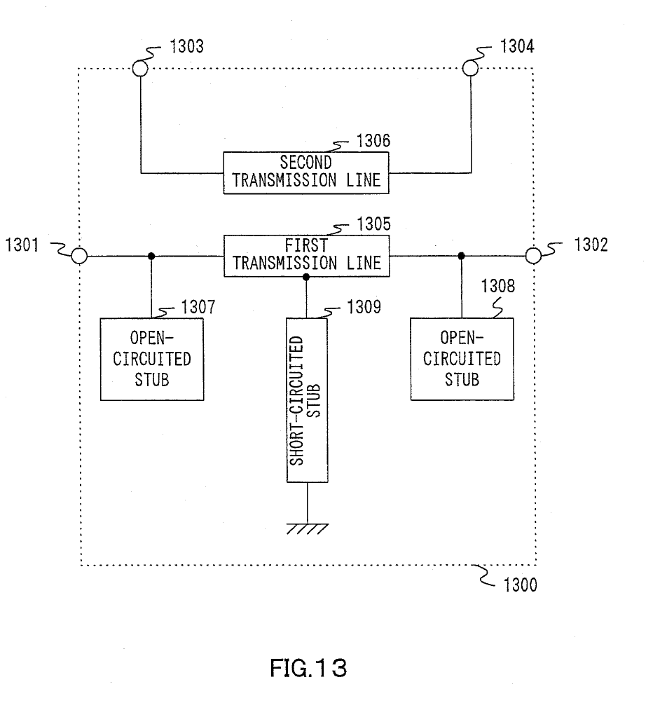

The fourth embodiment of the present invention will be described below with reference to FIGS. 13 to 16. FIG. 13 is a diagram illustrating an example of a configuration of a directional coupler according to the fourth embodiment of the present invention, where the directional coupler is applied to one for monitoring transmit power.

Directional coupler 1300 is primarily composed of input port 1301, output port 1302, coupling port 1303, isolation port 1304, first transmission line 1305, second transmission line 1306, open-circuited stubs 1307 and 1308, and short-circuited stub 1309. Input port 1301 is connected to output port 1302 via open-circuited stub 1307, first transmission line 1305 and open-circuited stub 1308. Short-circuited stub 1309 is disposed on first transmission line 1305. Coupling port 1303 is connected to isolation port 1304 via second transmission line 1306 in electromagnetic coupling with first transmission line 1305.

Open-circuited stubs 1307 and 1308 have the same characteristics, and have a stub length corresponding to ¼ wavelength in desired stop frequency fs11. Short-circuited stub 1309 has a stub length corresponding to ¼ wavelength in center frequency fo. It is assumed in the following description that the characteristic impedance of the directional coupler composed of first transmission line 1305 and second transmission line 1306 is the same as the impedance of an external circuit.

The following description is given of achieving unnecessary signal suppression in desired stop frequency. In the configuration illustrated in FIG. 13, according to previously mentioned equation (1), since first transmission line 1305 is short-circuited in stop frequency fs41 by open-circuited stubs 1307 and 1308, it is possible to suppress unnecessary signals in stop frequency fs41.

Susceptance Bos(f) of a short-circuited stub becomes infinite (Bos(fsss)=infinite) in frequency f=fsss such that an electric length of the stub corresponds to ½ wavelength. Accordingly, in frequency of fsss, impedance Zss obtained after inserting the short-circuited stub is not dependent on impedance Zip at a stub inserting point, and is expressed by following equation (2), and the circuit is short-circuited.

Zss(fsss)=1/{1/Zip+jBss(fsss)}=0Ω (2)

Accordingly, in the configuration illustrated in FIG. 13, in 2fo, short-circuited stub 1309 develops a short-circuit in first transmission line 1305, enabling the suppression of unnecessary signal in stop frequency 2fo.

A case will be described next of matching impedance of external circuits (not shown) connected to input and output ports of directional coupler 1300 in center frequency. In FIG. 13, first transmission line 1305, open-circuited stubs 1307 and 1308 and short-circuited stub 1309 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

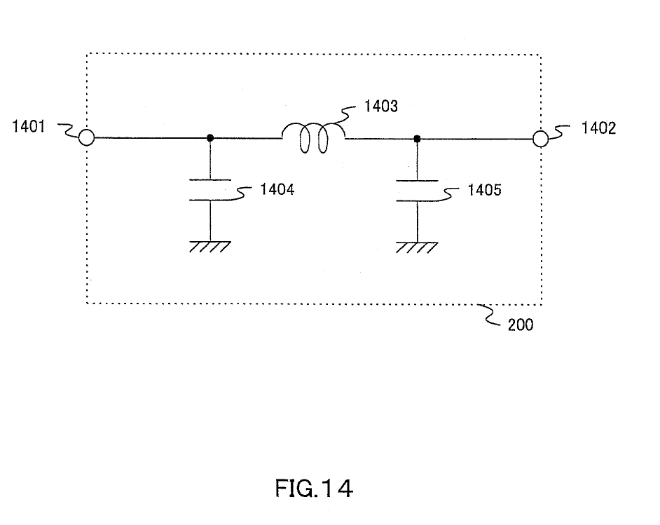

FIG. 14 illustrates matching circuit 1400 obtained by approximating elements connected between input port 1301 and output port 1302 in directional coupler 1300 in FIG. 13 by lumped-circuit elements in center frequency fo. In FIG. 14, input port 1401 corresponds to input port 1301 in FIG. 13, output port 1402 corresponds to output port 1302 in FIG. 13, inductor 1403 corresponds to first transmission line 1305 in FIG. 13, capacitor 1404 corresponds to open-circuited stub 1307 in FIG. 13, and capacitor 1405 corresponds to open-circuited stub 1308 in FIG. 13. Since short-circuited stub 1309 has a stub length corresponding to ¼ wavelength in center frequency fo, the susceptance becomes 0. Accordingly, in FIG. 14 short-circuited stub 1309 is neglected. Herein, since matching circuit 1400 has the same configuration as that of a π-section LC matching circuit, the circuit 1400 is capable of acquiring the matching between external circuits connected to input port 1401 and output port 1402, and as a result, is capable of decreasing a mismatching loss and of achieving low-loss characteristics.

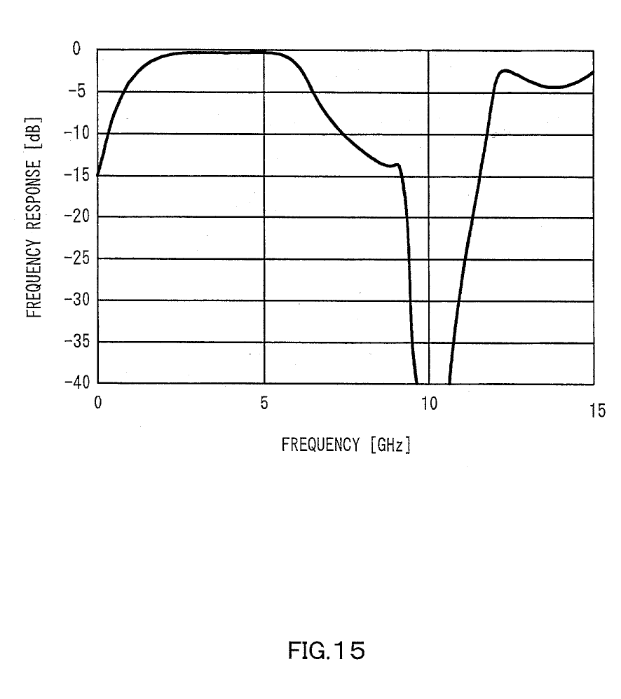

FIG. 15 is a diagram illustrating an example of characteristics of directional coupler 1300, and more specifically illustrates a calculated response in the case where Zos41=60ΩZss41=100Ω, center frequency fo=5 GHz, stop frequency fs41=10 GHz, characteristic impedance of first transmission line 1305 is 50Ω, phase angle is 67.40° in fo, and short-circuited stub 1309 is disposed at a middle point on first transmission line 1305. In addition, Zos41 is characteristic impedance of lines composing open-circuited stubs 1307 and 1308, and Zss41 is characteristic impedance of a line composing short-circuit 1309. A value obtained as a suppression amount in stop frequency is more than 40 dB in fs41 (10 GHz: corresponding to double-frequency). Further, suppression characteristics are obtained in a lower frequency band. In addition, since this design has the relationship of fs41=2 fo, the stop frequency by open-circuited stubs 1307 and 1308 is coincident with the stop frequency by short-circuited stub 1309. When electric lengths of open-circuited stubs 1307 and 1308 are changed, it is possible to obtain suppression characteristics in two different frequencies, i.e., stop frequency by open-circuited stubs 1307 and 1308, and stop frequency by short-circuited stub 1309.

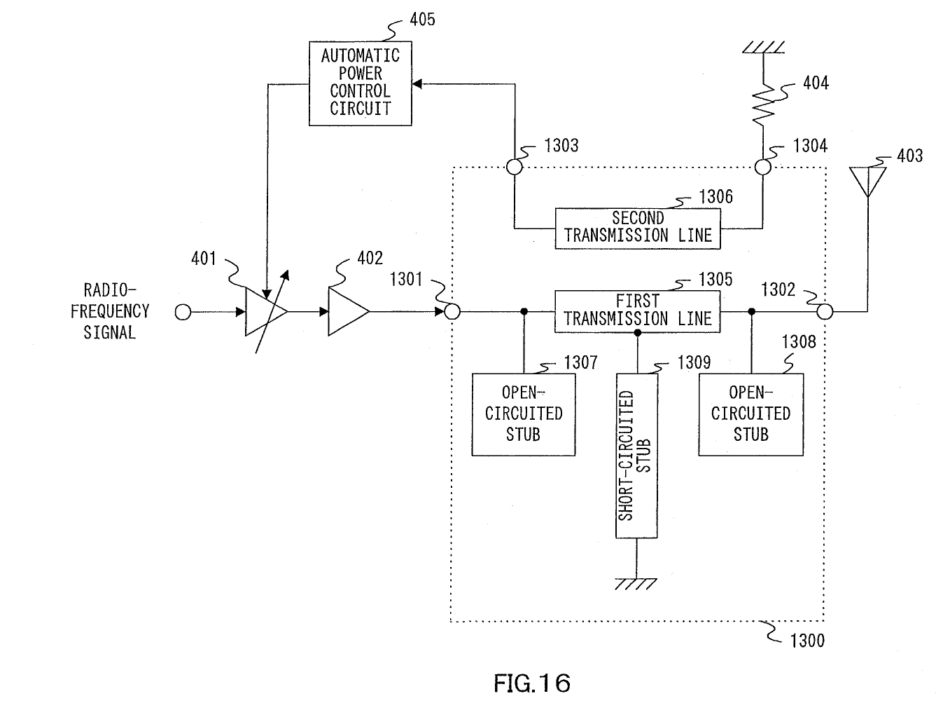

FIG. 16 is a specific example of a configuration of a radio communication apparatus applying the directional coupler according to the fourth embodiment of the present invention. The radio communication apparatus illustrated in FIG. 16 applies directional coupler 1300 substituted for directional coupler 100 in the radio communication apparatus illustrated in FIG. 4. As compared to the radio communication apparatus illustrated in FIG. 4, in the radio communication apparatus illustrated in FIG. 12, since it is possible to obtain suppression characteristics in low frequencies, it is possible to obtain spurious suppression characteristics with more excellence.

(Fifth Embodiment)

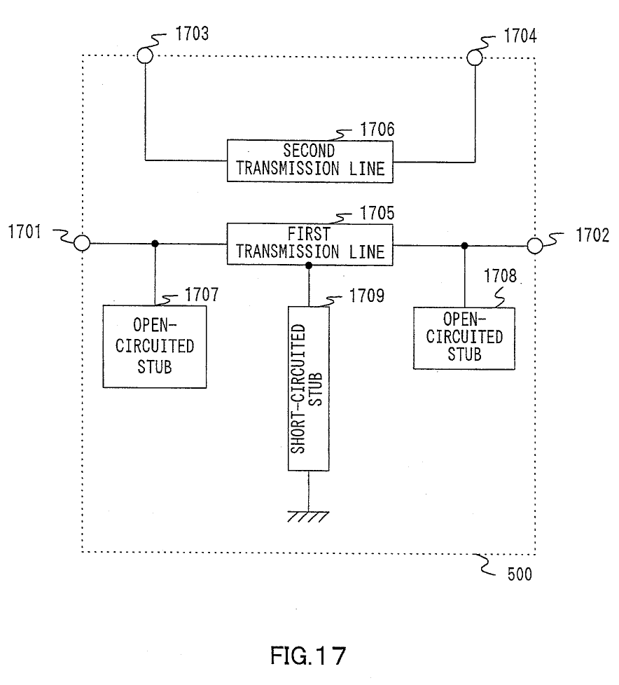

The fifth embodiment of the present invention will be described below with reference to FIGS. 17 to 20. FIG. 17 is a diagram illustrating an example of a configuration of a directional coupler according to the fifth embodiment of the present invention, where the directional coupler is applied to one for monitoring transmit power.

Directional coupler 1700 is primarily composed of input port 1701, output port 1702, coupling port 1703, isolation port 1704, first transmission line 1705, second transmission line 1706, open-circuited stubs 1707 and 1708, and short-circuited stub 1709. Input port 1701 is connected to output port 1702 via open-circuited stub 1707, first transmission line 1705 and open-circuited stub 1708. Short-circuited stub 1709 is disposed on first transmission line 1705. Coupling port 1703 is connected to isolation port 1704 via second transmission line 1706 in electromagnetic coupling with first transmission line 1705.

Open-circuited stubs 1707 and 1708 have a stub length corresponding to ¼ wavelength in two different cut-off frequencies, i.e., fs51 and fs52, respectively. Further, short-circuited stub 1709 has a stub length corresponding to ¼ wavelength in desired center frequency fo. It is assumed in the following description that the characteristic impedance of the directional coupler composed of first transmission line 1705 and second transmission line 1706 is the same as the impedance of an external circuit.

The following description is given of achieving unnecessary signal suppression in desired stop frequency. In the configuration illustrated in FIG. 17, according to previously mentioned equation (1), since first transmission line 1705 is short-circuited in stop frequency fs51 by open-circuited stub 1707 and in stop frequency fs52 by open-circuited stub 1708, it is possible to suppress unnecessary signals in two different cut-off frequencies, i.e., fs51 and fs52. Further in the configuration illustrated in FIG. 17, according to previously mentioned equation (2), since first transmission line 1705 is short-circuited in stop frequency 2fo by short-circuited stub 1709, it is possible to suppress unnecessary signals in stop frequency 2fo.

A case will be described next of matching impedance of external circuits (not shown) connected to input and output ports of directional coupler 1700 in center frequency. First transmission line 1705, open-circuited stubs 1707 and 1708 and short-circuited stub 1709 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

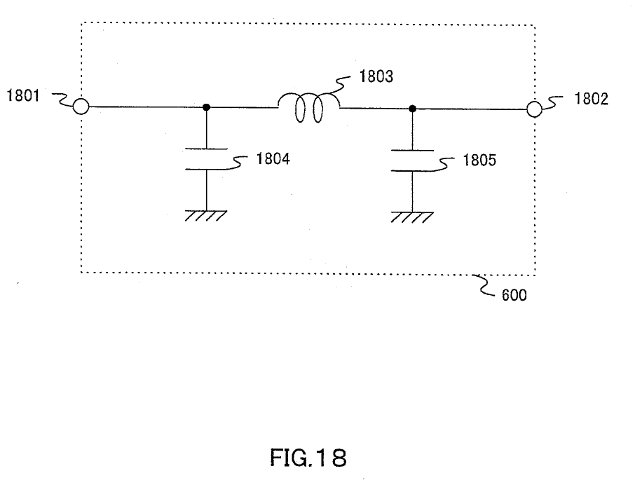

FIG. 18 illustrates matching circuit 1800 obtained by approximating elements connected between input port 1701 and output port 1702 in directional coupler 1700 in FIG. 17 by lumped-circuit elements in center frequency fo. In FIG. 18, input port 1801 corresponds to input port 1701 in FIG. 17, output port 1802 corresponds to output port 1702 in FIG. 17, inductor 1803 corresponds to first transmission line 1705 in FIG. 17, capacitor 1804 corresponds to open-circuited stub 1707 in FIG. 17, and capacitor 1805 corresponds to open-circuited stub 1708 in FIG. 17. Since short-circuited stub 1709 has a stub length corresponding to ¼ wavelength in center frequency fo, the susceptance becomes 0. Accordingly, in FIG. 18 short-circuited stub 1709 is neglected. Herein, since matching circuit 1800 has the same configuration as that of a π-section LC matching circuit, the circuit 1800 is capable of acquiring the matching between external circuits connected to input port 1801 and output port 1802, and as a result, is capable of decreasing a mismatching loss and of achieving low-loss characteristics.

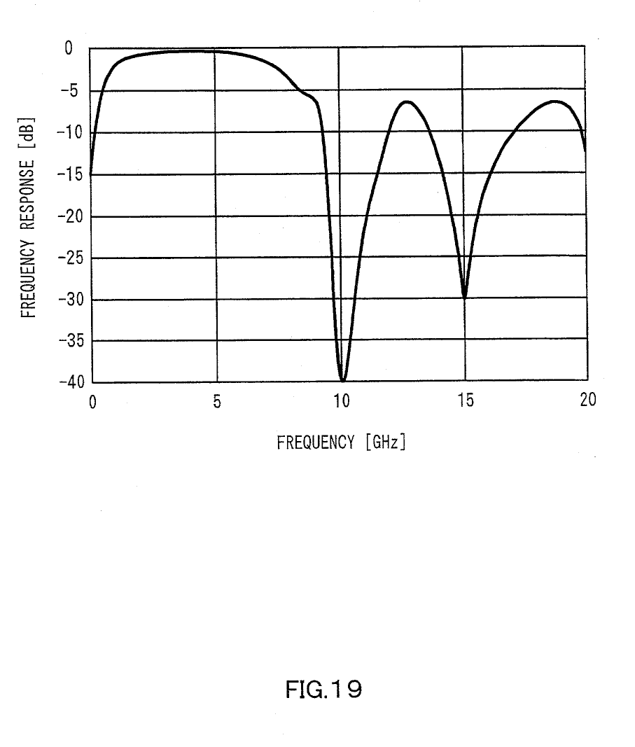

FIG. 19 is a diagram illustrating an example of characteristics of directional coupler 1700, and more specifically illustrates a calculated response in the case where Zos51=90Ω, Zos52=52Ω, Zss51=100Ω, center frequency fo=5 GHz, cut-off frequencies fs51=10 GHz and fs52=15 GHz, characteristic impedance of first transmission line 1705 is 50Ω, phase angle is 74.5° in fo, and short-circuited stub 1709 is disposed at a middle point of first transmission line 1705. Values obtained as a suppression amount in stop frequency are more than 40 dB in fs51 (10 GHz: corresponding to double-frequency), and more than 25 dB in fs52 (15 GHz: corresponding to triple-frequency).

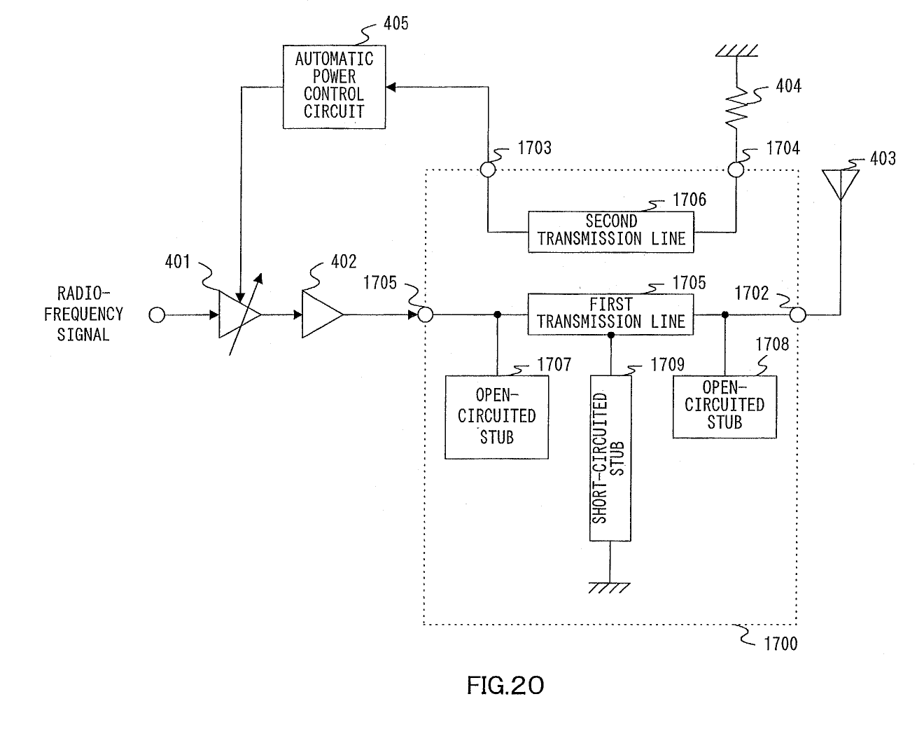

FIG. 20 is a specific example of a configuration of a radio communication apparatus applying the directional coupler according to the fifth embodiment of the present invention. The radio communication apparatus illustrated in FIG. 20 applies directional coupler 1700 substituted for directional coupler 100 in the radio communication apparatus illustrated in FIG. 4. As compared to the radio communication apparatus illustrated in FIG. 4, in the radio communication apparatus illustrated in FIG. 20, since the function of canceling spurious in two different cut-off frequencies is added to the directional coupler, it is possible to obtain spurious suppression characteristics with more excellence. Further, since it is possible to obtain suppression characteristics in low frequencies, it is possible to obtain spurious suppression characteristics with more excellence.

(Sixth Embodiment)

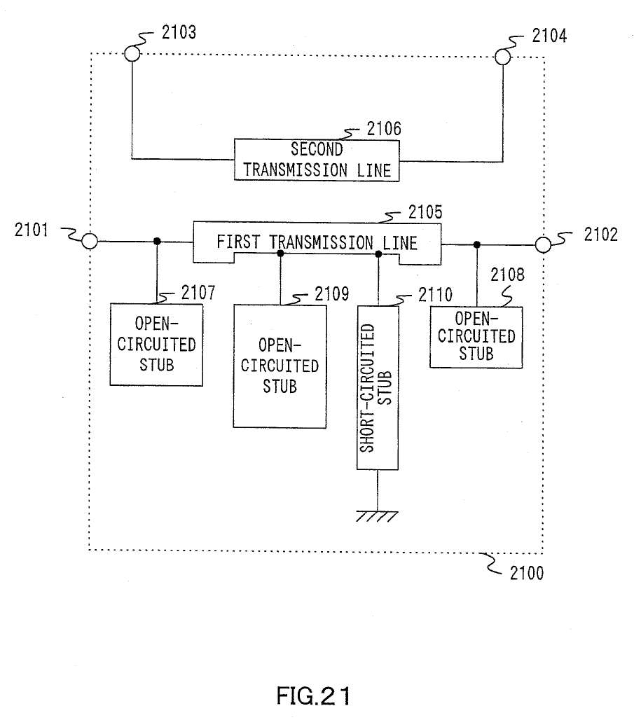

The sixth embodiment of the present invention will be described below with reference to FIGS. 21 to 24. FIG. 21 is a diagram illustrating an example of a configuration of a directional coupler according to the sixth embodiment of the present invention, where the directional coupler is applied to one for monitoring transmit power.

Directional coupler 2100 is primarily composed of input port 2101, output port 2102, coupling port 2103, isolation port 2104, first transmission line 2105, second transmission line 2106, and open-circuited stubs 2107, 2108 and 2109, and short-circuited stub 2110. Input port 2101 is connected to output port 2102 via open-circuited stub 2107, first transmission line 2105 and open-circuited stub 2108. Open-circuited stub 2109 and short-circuited stub are disposed on first transmission line 2105. Coupling port 2103 is connected to isolation port 2104 via second transmission line 2106 in electromagnetic coupling with first transmission line 2105.

Open-circuited stubs 2107, 2108 and 2109 have a stub length corresponding to ¼ wavelength in three different cut-off frequencies, i.e., fs61, fs62 and fs63, respectively. Short-circuited stub has a stub length corresponding to ¼ wavelength in desired center frequency fo. In addition, it is not necessary for first transmission line 2105 and second transmission line 2106 to have the same length.

The following description is given of achieving unnecessary signal suppression in desired stop frequency. In the configuration illustrated in FIG. 21, according to previously mentioned equation (1), since first transmission line 2105 is short-circuited in stop frequency fs61 by open-circuited stub 2107, in stop frequency fs62 by open-circuited stub 2108, and in stop frequency f63 by open-circuited stub 2109, it is possible to suppress unnecessary signals in three different cut-off frequencies, i.e., fs61, fs62 and fs63. Further in the configuration illustrated in FIG. 21, according to previously mentioned equation (2), since first transmission line 2105 is short-circuited in 2fo by short-circuited stub 2110, it is possible to suppress unnecessary signals in stop frequency 2fo.

A case will be described next of matching impedance of external circuits (not shown) connected to input and output ports of directional coupler 2100 in center frequency. First transmission line 2105, open-circuited stubs 2107, 2108 and 2109, and short-circuited stub 2110 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

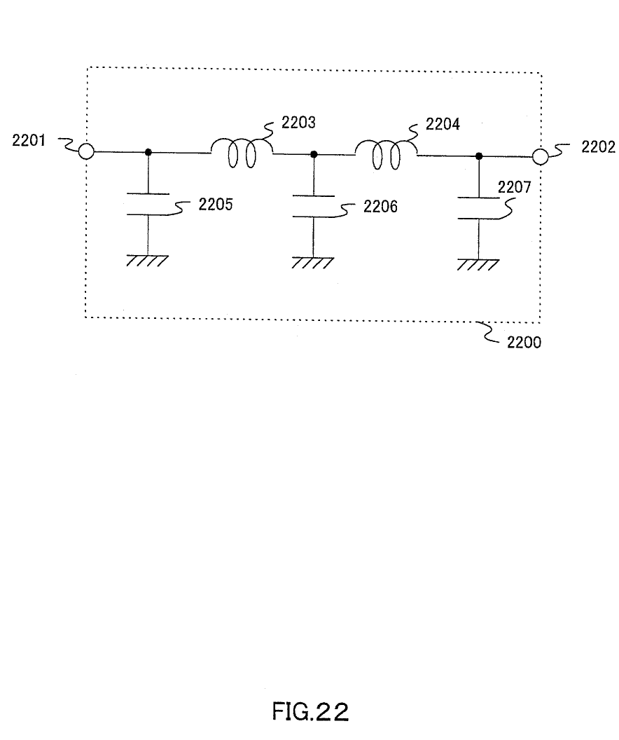

FIG. 22 illustrates matching circuit 2200 obtained by approximating elements connected between input port 2101 and output port 2102 in directional coupler 2100 in FIG. 21 by lumped-circuit elements in center frequency fo. In FIG. 22, input port 2201 corresponds to input port 2101 in FIG. 21, output port 2202 corresponds to output port 2102 in FIG. 21, inductors 2203 and 2204 correspond to first transmission line 2105 in FIG. 21, capacitor 2205 corresponds to open-circuited stub 2107 in FIG. 21, capacitor 2206 corresponds to open-circuited stub 2109 in FIG. 21, and capacitor 2207 corresponds to open-circuited stub 2108 in FIG. 21. Since short-circuited stub 2110 has a stub length corresponding to ¼ wavelength in center frequency fo, the susceptance becomes 0. Accordingly, in FIG. 22 short-circuited stub 2110 is neglected. Herein, since matching circuit 2200 has the same configuration as that of an LC multistage π-section matching circuit, the circuit 2200 is capable of acquiring the matching between external circuits connected to input port 2201 and output port 2202, and as a result, is capable of decreasing a mismatching loss and of achieving low-loss characteristics.

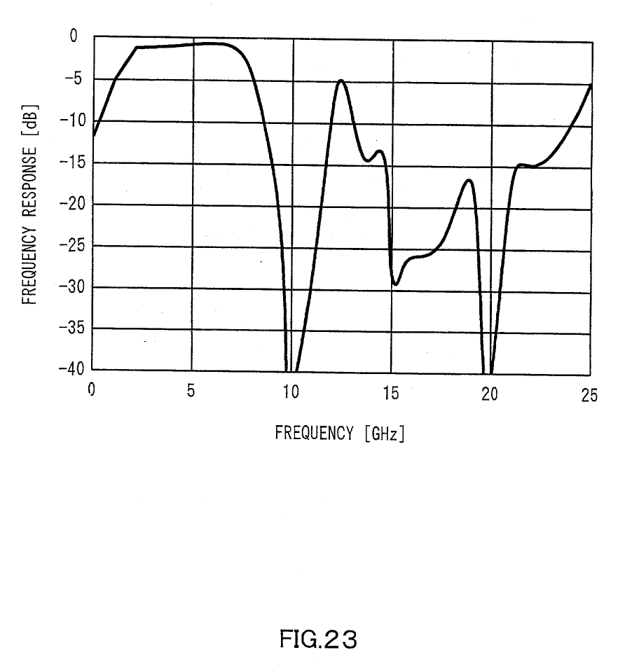

FIG. 23 illustrates, as an example of characteristics of directional coupler 2100 in FIG. 21, a simulation of characteristics of directional coupler 2100 in the case where Zos61=57.7Ω, Zos62=41.4Ω, Zos63=55Ω, center frequency fo=5 GHz, cut-off frequencies fs61=10 GHz, fs62=15 GHz and fs63=20 GHz, characteristic impedance of first transmission line 2105 is 50Ω, phase angle is 133.2°, open-circuited stub 2109 is disposed at a middle point on first transmission line 2105, and short-circuited stub 2110 is disposed at a middle point between open-circuited stubs 2108 and 2109. In addition, Zos61, Zos62 and Zos63 are impedance of lines composing open-circuited stubs 2107, 2108 and 2109 in FIG. 21 respectively. Values obtained as a suppression amount in stop frequency are more than 40 dB in fs61 (10 GHz: corresponding to double-frequency), more than 25 dB in fs62 (15 GHz: corresponding to triple-frequency), and more than 40 dB in fs63 (20 GHz: corresponding to four-time-frequency).

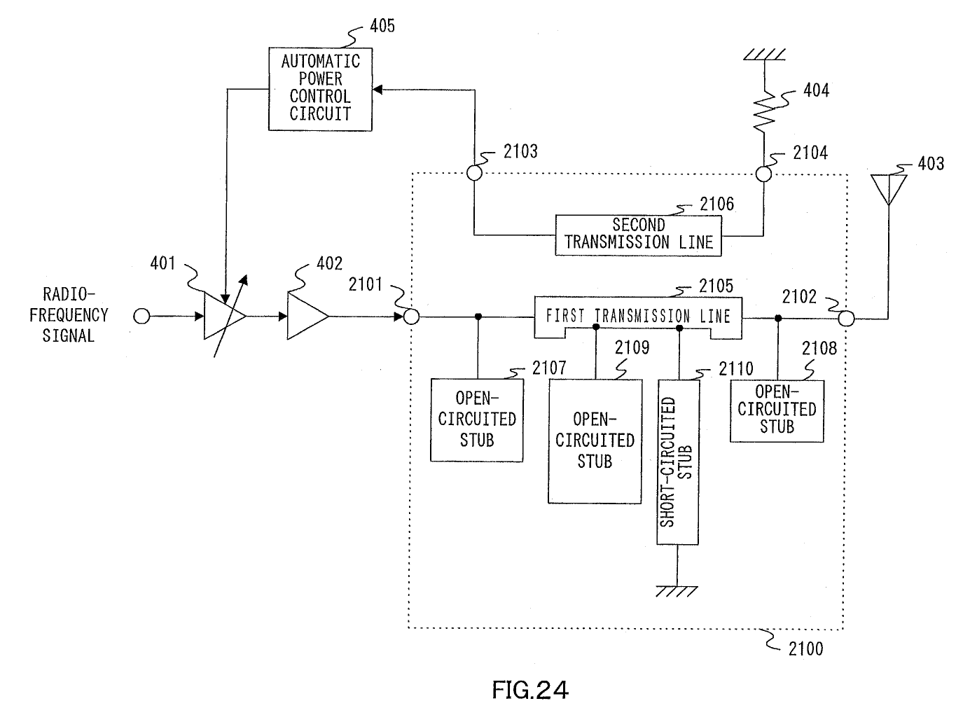

FIG. 24 is a specific example of a configuration of a radio communication apparatus applying the directional coupler according to the sixth embodiment of the present invention. The radio communication apparatus illustrated in FIG. 24 applies directional coupler 2100 substituted for directional coupler 100 in the radio communication apparatus illustrated in FIG. 4. As compared to the radio communication apparatus illustrated in FIG. 4, in the radio communication apparatus illustrated in FIG. 24, since the function of canceling spurious in three different cut-off frequencies is added to directional coupler 2100, it is possible to obtain spurious suppression characteristics with more excellence. Further, since it is possible to obtain suppression characteristics in low frequencies, it is possible to obtain spurious suppression characteristics with more excellence.

(Seventh Embodiment)

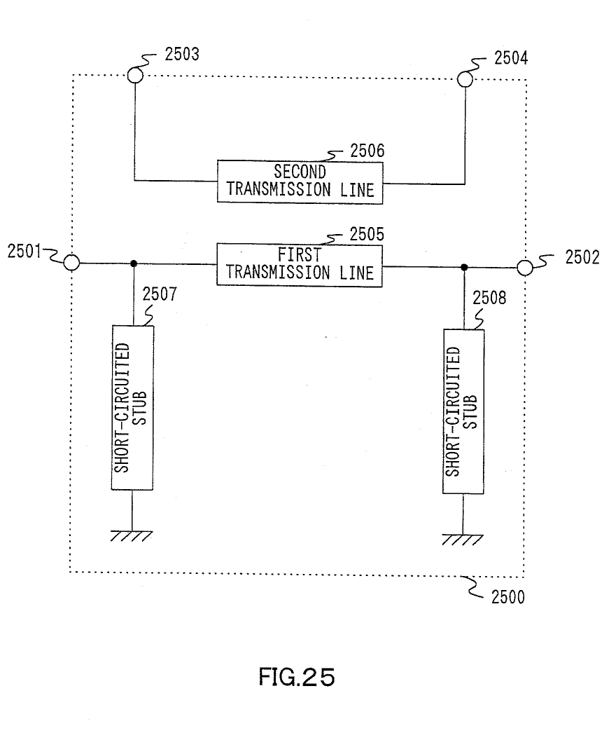

The seventh embodiment of the present invention will be described with reference to FIGS. 25 to 28. FIG. 25 is a diagram illustrating an example of a configuration of a directional coupler according to the seventh embodiment of the present invention, where the directional coupler is applied to one for monitoring transmit power.

Directional coupler 2500 is primarily composed of input port 2501, output port 2502, coupling port 2503, isolation port 2504, first transmission line 2505, second transmission line 2506, and short-circuited stubs 2507 and 2508. Input port 2501 is connected to output port 2502 via short-circuited stub 2507, first transmission line 2505 and short-circuited stub 2508. Coupling port 2503 is connected to isolation port 2504 via second transmission line 2506 in electromagnetic coupling with first transmission line 2505.

Short-circuited stubs 2507 and 2508 have the same characteristics, and have a stub length corresponding to ½ wavelength in desired stop frequency fs71. It is not necessary for first transmission line 2505 and second transmission line 2506 to have the same length.

The following description is given of achieving unnecessary signal suppression in desired stop frequency. In the configuration illustrated in FIG. 25, according to previously mentioned equation (2), since first transmission line 2505 is short-circuited in stop frequency fs71 by short-circuited stubs 2507 and 2508, it is possible to suppress unnecessary signals in stop frequency fs71.

A case will be described next of matching impedance of external circuits (not shown) connected to input and output ports of directional coupler 2500 in center frequency. First transmission line 2505 and short-circuited stubs 2507 and 2508 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

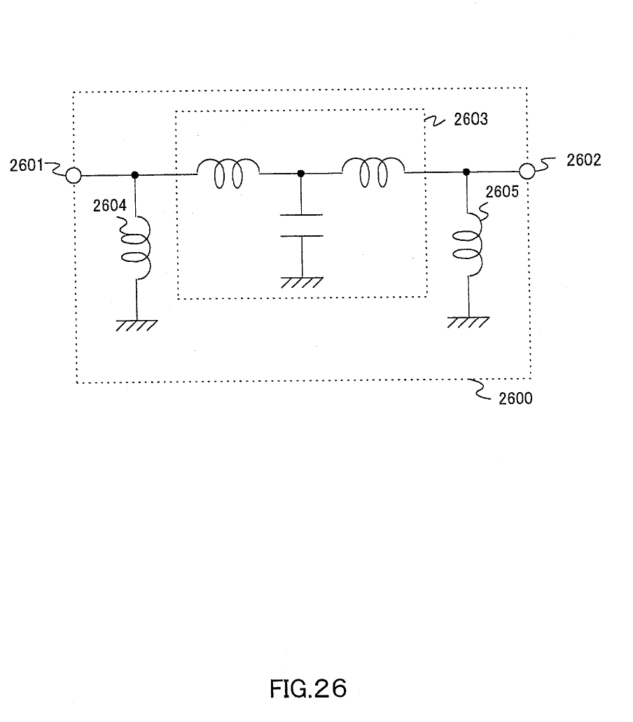

FIG. 26 illustrates matching circuit 2600 obtained by approximating elements connected between input port 2501 and output port 2502 in directional coupler 2500 in FIG. 25 by lumped-circuit elements in center frequency fo. In FIG. 26, input port 2601 corresponds to input port 2501 in FIG. 25, output port 2602 corresponds to output port 2502 in FIG. 25, inductor 2603 corresponds to first transmission line 2505 in FIG. 25, inductor 2604 corresponds to short-circuited stub 2507 in FIG. 25, and inductor 2605 corresponds to short-circuited stub 2508 in FIG. 25. Herein, since matching circuit 2600 has the same configuration as that of a π-section LC matching circuit, the circuit 2600 is capable of acquiring the matching between external circuits connected to input port 2601 and output port 2602, and as a result, is capable of decreasing a mismatching loss and of achieving low-loss characteristics.

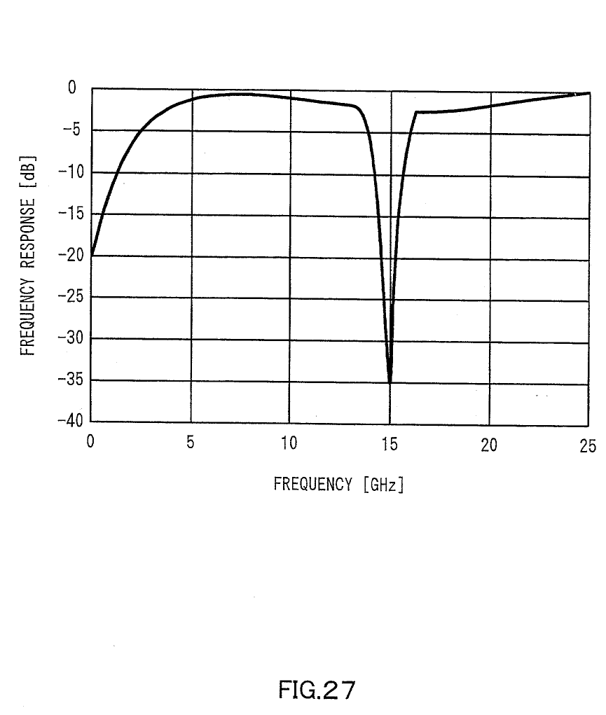

FIG. 27 is a diagram illustrating an example of characteristics of directional coupler 2500, and more specifically illustrates a calculated response in the case where Zss71=Zss72=100Ω, center frequency fo=5 GHz, stop frequency fs71=15 GHz, characteristic impedance of first transmission line 2105 is 50Ω, and phase angle is 98.2°. In addition, Zss71 and Zss72 are impedance of lines composing short-circuited stubs 2507 and 2508. A value obtained as a suppression amount in stop frequency is more than 30 dB in fs71 (15 GHz: corresponding to triple-frequency). Further, suppression characteristics are obtained in low frequencies.

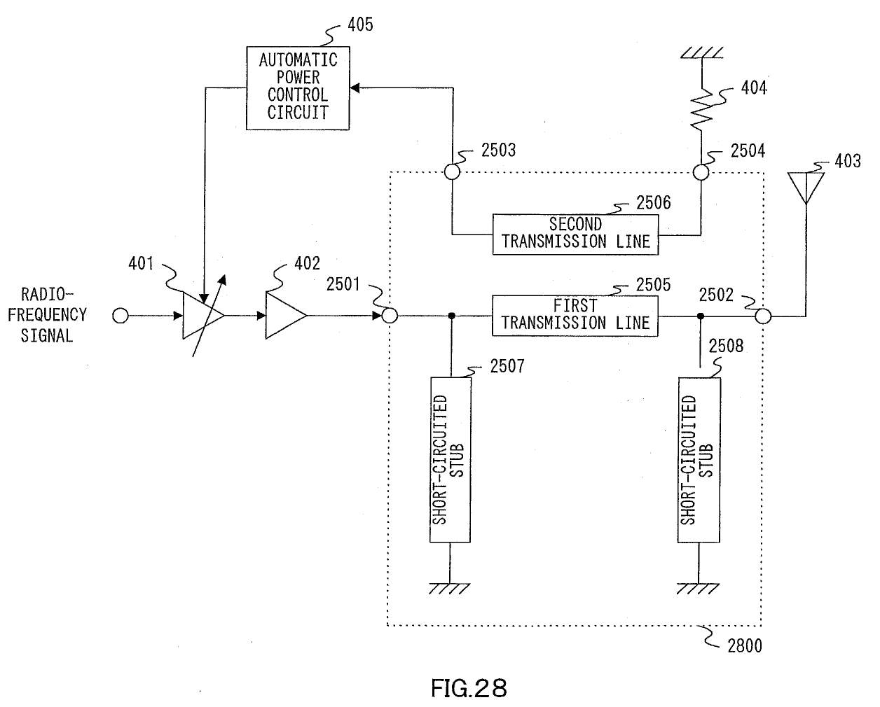

FIG. 28 is a specific example of a configuration of a radio communication apparatus applying the directional coupler according to the seventh embodiment of the present invention. The radio communication apparatus illustrated in FIG. 28 applies directional coupler 2500 substituted for directional coupler 100 in the radio communication apparatus illustrated in FIG. 4. As compared to the radio communication apparatus illustrated in FIG. 4, in the radio communication apparatus illustrated in FIG. 28, since it is possible to obtain suppression characteristics in low frequencies, it is possible to obtain spurious suppression characteristics with more excellence.

(Eighth Embodiment)

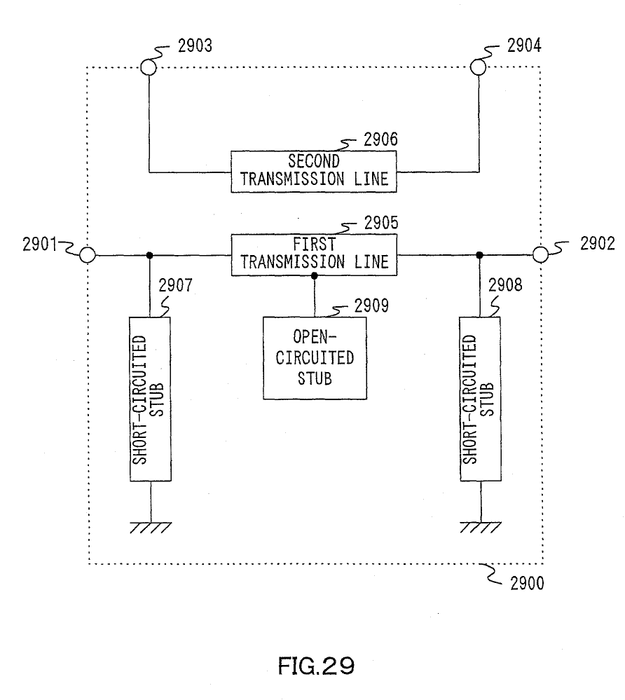

The eighth embodiment of the present invention will be described below with reference to FIGS. 29 to 32. FIG. 29 is a diagram illustrating an example of a configuration of a directional coupler according to the eighth embodiment of the present invention, where the directional coupler is applied to one for monitoring transmit power.

Directional coupler 2900 is primarily composed of input port 2901, output port 2902, coupling port 2903, isolation port 2904, first transmission line 2905, second transmission line 2906, short-circuited stubs 2907 and 2908, and open-circuited stub 2909. Input port 2901 is connected to output port 2902 via short-circuited stub 2907, first transmission line 2905 and short-circuited stub 2908. Open-circuited stub 2909 is disposed on first transmission line 2905. Coupling port 2903 is connected to isolation port 2904 via second transmission line 2906 in electromagnetic coupling with first transmission line 2905.

Short-circuited stubs 2907 and 2908 have the same characteristics and a stub length corresponding to ½ wavelength in desired stop frequency fs81. Further, open-circuited stub 2909 has a stub length corresponding to ¼ wavelength in stop frequency fs82. In addition, it is not necessary for first transmission line 2905 and second transmission line 2906 to have the same length.

The following description is given of achieving unnecessary signal suppression in desired stop frequency. In the configuration illustrated in FIG. 29, according to previously mentioned equation (2), since first transmission line 2905 is short-circuited in stop frequency fs81 by short-circuited stubs 2907 and 2908, it is possible to suppress unnecessary signals in stop frequency fs81. Further, according to previously mentioned equation (1), since first transmission line 2905 is short-circuited in stop frequency fs82 by open-circuited stub 2909, it is possible to suppress unnecessary signals in stop frequency fs82.

A case will be described next of matching impedance of external circuits (not shown) connected to input and output ports of directional coupler 2900 in center frequency. First transmission line 2905, short-circuited stubs 2907 and 2908 and open-circuited stub 2909 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

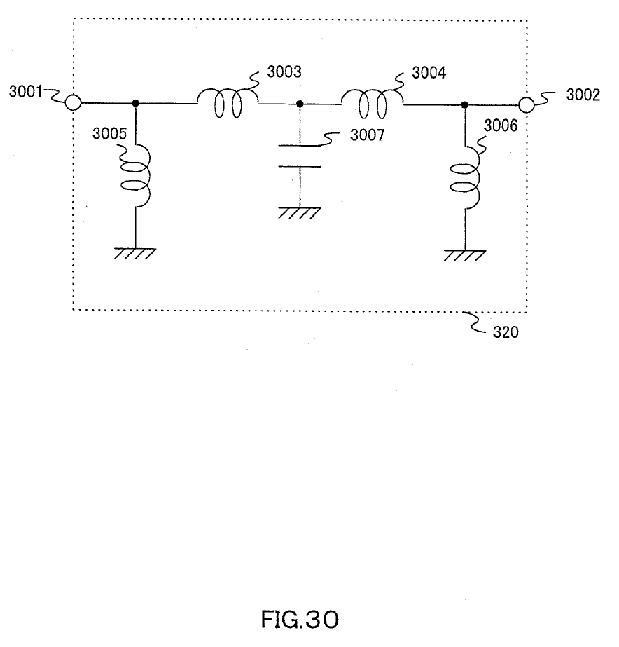

FIG. 30 illustrates matching circuit 3000 obtained by approximating elements connected between input port 2901 and output port 2902 in directional coupler 2900 in FIG. 29 by lumped-circuit elements in center frequency fo. In FIG. 30, input port 3001 corresponds to input port 2901 in FIG. 29, output port 3002 corresponds to output port 2902 in FIG. 29, inductors 3003 and 3004 correspond to first transmission line 2905 in FIG. 29, inductor 3005 corresponds to short-circuited stub 2907 in FIG. 29, inductor 3006 corresponds to short-circuited stub 2908 in FIG. 29, and capacitor 3007 corresponds to open-circuited stub 2909 in FIG. 29. Herein, since matching circuit 3000 has the same configuration as that of an LC multistage π-section matching circuit, the circuit 3000 is capable of acquiring the matching between external circuits connected to input port 3001 and output port 3002, and as a result, is capable of decreasing a mismatching loss and of achieving low-loss characteristics.

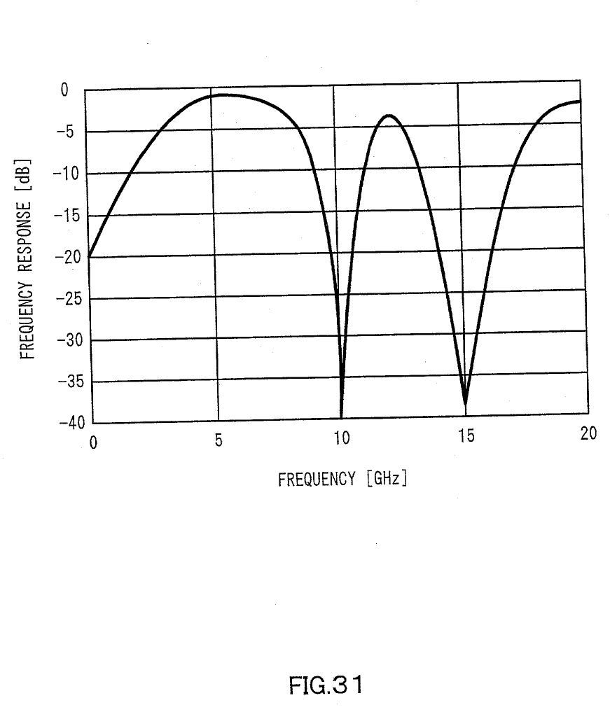

FIG. 31 is a diagram illustrating an example of characteristics of directional coupler 2900, and more specifically illustrates a calculated response in the case where Zss81=Zss82=50Ω, Zss83=69.1Ω, center frequency fo=5 GHz, cut-off frequencies fs81=15 GHz and fs82=10 GHz, characteristic impedance of first transmission line 2905 is 50Ω, phase angle is 28.9°, and open-circuited stub 2909 is disposed at a middle point of first transmission line 2905. In addition, Zss81 and Zss82 are impedance of lines composing short-circuited stubs 2907 and 2908, and Zss83 is impedance of a line composing open-circuited stub 2909. Values obtained as a suppression amount in stop frequency are more than 35 dB in fs81 (15 GHz: corresponding to triple-frequency), and more than 30 dB in fs82 (10 GHz: corresponding to double-frequency). Further, suppression characteristics are obtained in low frequencies.

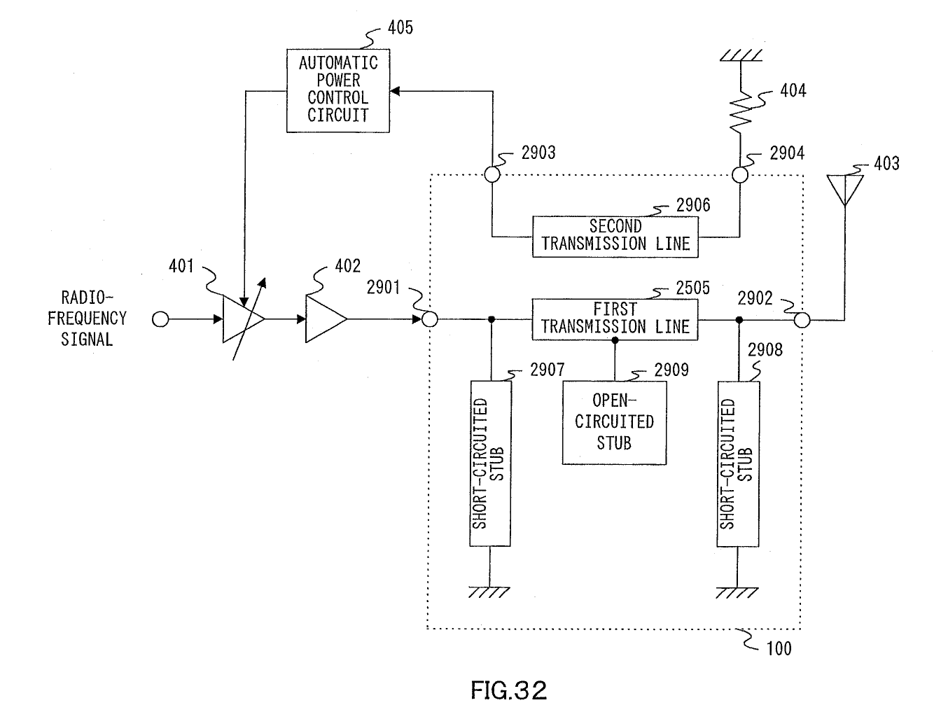

FIG. 32 is a specific example of a configuration of a radio communication apparatus applying the directional coupler according to the eighth embodiment of the present invention. The radio communication apparatus illustrated in FIG. 32 applies directional coupler 2900 substituted for directional coupler 100 in the radio communication apparatus illustrated in FIG. 4. As compared to the radio communication apparatus illustrated in FIG. 4, in the radio communication apparatus illustrated in FIG. 32, since the function of canceling spurious in two different cut-off frequencies is added to the directional coupler, it is possible to obtain spurious suppression characteristics with more excellence. Further, since it is possible to obtain suppression characteristics in low frequencies, it is possible to obtain spurious suppression characteristics with more excellence.

(Ninth Embodiment)

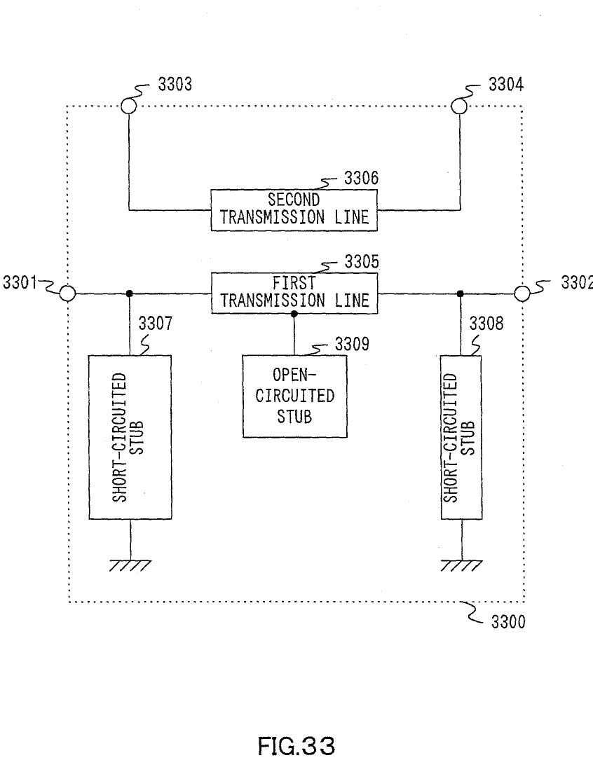

The ninth embodiment of the present invention will be described below with reference to FIGS. 33 to 36. FIG. 33 is a diagram illustrating an example of a configuration of a directional coupler according to the ninth embodiment of the present invention, where the directional coupler is applied to one for monitoring transmit power.

Directional coupler 3300 is primarily composed of input port 3301, output port 3302, coupling port 3303, isolation port 3304, first transmission line 3305, second transmission line 3306, short-circuited stubs 3307 and 3308, and open-circuited stub 3309. Input port 3301 is connected to output port 3302 via short-circuited stub 3307, first transmission line 3305 and short-circuited stub 3308. Open-circuited stub 3309 is disposed on first transmission line 3305. Coupling port 3303 is connected to isolation port 3304 via second transmission line 3306 in electromagnetic coupling with first transmission line 3305.

Short-circuited stubs 3307 and 3308 have a stub length corresponding to ½ wavelength in two different cut-off frequencies, i.e., fs91 and fs92, respectively. Further, open-circuited stub 3309 has a stub length corresponding to ¼ wavelength in stop frequency fs93. In addition, it is not necessary for first transmission line 3305 and second transmission line 3306 to have the same length.

The following description is given of achieving unnecessary signal suppression in desired stop frequency. In the configuration illustrated in FIG. 33, according to previously mentioned equation (2), since first transmission line 3305 is short-circuited in stop frequency fs91 by short-circuited stub 3307, and in stop frequency fs92 by short-circuited stub 3308, it is possible to suppress unnecessary signals in cut-off frequencies fs91 and fs92. Further, according to previously mentioned equation (1), since first transmission line 3305 is short-circuited in stop frequency fs93 by open-circuited stub 3309, it is possible to suppress unnecessary signals in stop frequency fs93.

A case will be described next of matching impedance of external circuits (not shown) connected to input and output ports of directional coupler 3300 in center frequency. First transmission line 3305, short-circuited stubs 3307 and 3308 and open-circuited stub 3309 are, for example, composed of distributed-circuit elements such as micro strip lines. Generally, a distributed-circuit element has frequency characteristics different from those of a lumped-circuit element such as an inductor and capacitor, but it is possible to approximate a lumped-circuit element by a distributed-circuit element with accuracy exclusively for a single frequency.

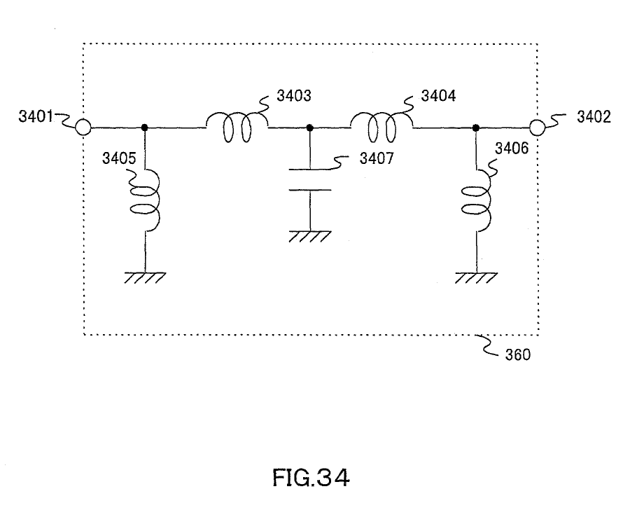

FIG. 34 illustrates matching circuit 3400 obtained by approximating elements connected between input port 3301 and output port 3302 in directional coupler 3300 in FIG. 33 by lumped-circuit elements in center frequency fo. In FIG. 34, input port 3401 corresponds to input port 3301 in FIG. 33, output port 3402 corresponds to output port 3302 in FIG. 33, inductors 3403 and 3404 correspond to first transmission line 3305 in FIG. 33, inductor 3405 corresponds to short-circuited stub 3307 in FIG. 33, inductor 3406 corresponds to short-circuited stub 3308 in FIG. 33, and capacitor 3407 corresponds to open-circuited stub 3309 in FIG. 33. Herein, since matching circuit 3400 has the same configuration as that of an LC multistage π-section matching circuit, the circuit 3400 is capable of acquiring the matching between external circuits connected to input port 3401 and output port 3402, and as a result, is capable of decreasing a mismatching loss and of achieving low-loss characteristics.

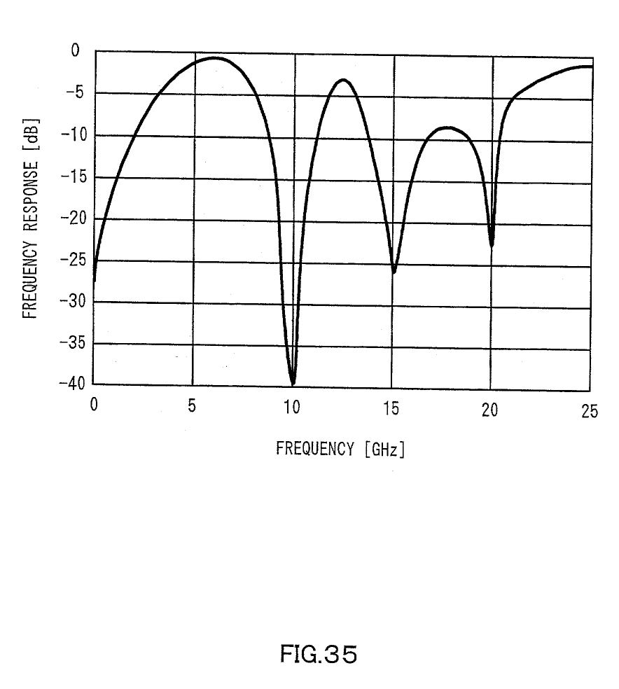

FIG. 35 is a diagram illustrating an example of characteristics of directional coupler 3300, and more specifically illustrates a calculated response in the case where Zss91=50Ω, Zss92=86.7Ω, Zss93=69.1Ω, center frequency fo=5 GHz, cut-off frequencies fs91=15 GHz, fs92=20 GHz and fs93=10 GHz, characteristic impedance of first transmission line 3305 is 50Ω, phase angle is 28.90°, and open-circuited stub 3309 is disposed at a middle point on first transmission line 3305. In addition, Zss91 and Zss92 are impedance of lines composing short-circuited stubs 3307 and 3308, and Zss93 is impedance of a line composing open-circuited stub 3309. Values obtained as a suppression amount in stop frequency are more than 20 dB in fs91 (15 GHz: corresponding to triple-frequency), more than 20 dB in fs92 (20 GHz: corresponding to four-time-frequency), and more than 35 dB in fs93 (10 GHz: corresponding to double-frequency). Further, suppression characteristics are obtained in low frequencies.

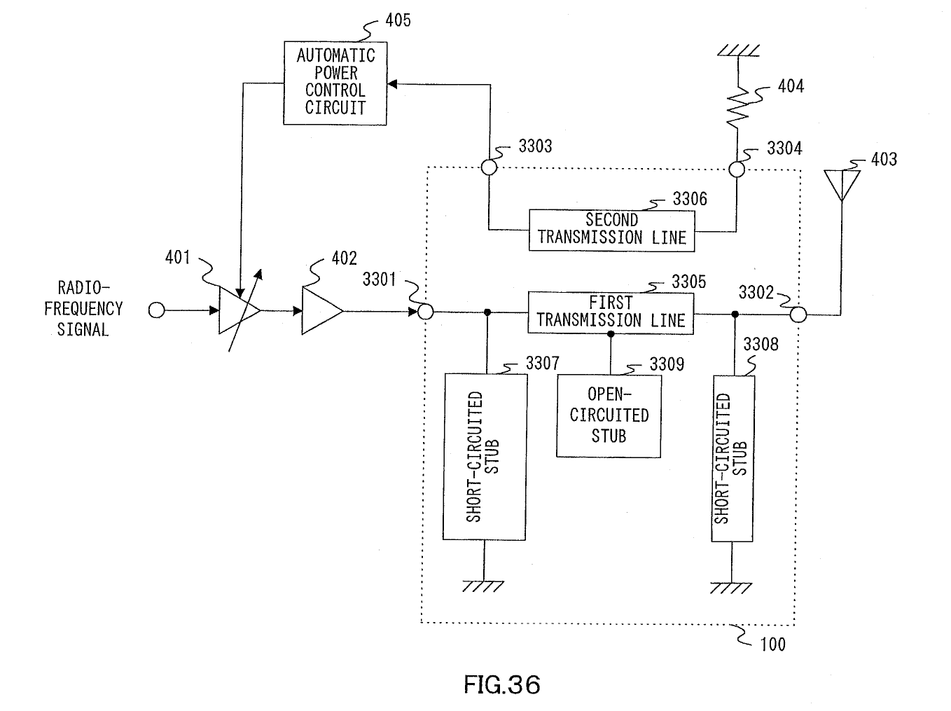

FIG. 36 is a specific example of a configuration of a radio communication apparatus applying the directional coupler according to the ninth embodiment of the present invention. The radio communication apparatus illustrated in FIG. 36 applies directional coupler 3300 substituted for directional coupler 100 in the radio communication apparatus illustrated in FIG. 4. As compared to the radio communication apparatus illustrated in FIG. 4, in the radio communication apparatus illustrated in FIG. 36, since the function of canceling spurious in at least two different cut-off frequencies is added to the directional coupler, it is possible to obtain spurious suppression characteristics with more excellence. Further, since it is possible to obtain suppression characteristics in low frequencies, it is possible to obtain spurious suppression characteristics with more excellence.

As described above, according to the present invention, stubs for radio-frequency spurious suppression are disposed at input and output sides of a first transmission line of a directional coupler, using the stubs with susceptance and the first transmission line acquires impedance matching in carrier frequency between circuits connected to input and output ports, and thereby it is possible to achieve the miniaturization and harmonic spurious suppression effect with a low loss and with excellence even in microwave/millimeter wave band.

This application is based on the Japanese Patent Application No. 2000-202665 filed on Jul. 4, 2000, entire content of which is expressly incorporated by reference herein.

Industrial Applicability

The present invention is suitable for use in radio communication apparatus such as a cellular phone and data radio communication port.

1. A directional coupler comprising:
a first transmission line through which a radio-frequency signal is transmitted;
a second transmission line in electromagnetic coupling with the first transmission line;
a first open-circuited stub connected to an input side of the first transmission line; and
a second open-circuited stub connected to an output side of the first transmission line,
wherein each of the first open-circuited stub and the second open-circuited stub has a stub length that causes a short circuit in desired frequency, and the first transmission line, the first open-circuited stub and the second open-circuited stub compose a circuit for impedance matching in center frequency with an external circuit.

2. The directional coupler according to claim 1, wherein the first open-circuited stub and the second open-circuited stub cause a short circuit in different frequencies.

3. The directional coupler according to claim 1, further comprising:
a third open-circuited stub, connected to the first transmission line, having a stub length that causes a short circuit in frequency different from frequencies of the first open-circuited stub and the second open-circuited stub, wherein the first transmission line, the first open-circuited stub, the second open-circuited stub and the third open-circuited stub compose the circuit for impedance matching in center frequency with an external circuit.

4. The directional coupler according to claim 1, further comprising:
a short-circuited stub, connected to the first transmission line, having a stub length that causes a short circuit in desired frequency, wherein the first transmission line, the first open-circuited stub, the second open-circuited stub and the short-circuited stub compose the circuit for impedance matching in center frequency with an external circuit.

5. The directional coupler according to claim 4, wherein the first open-circuited stub and the second open-circuited stub cause a short circuit in different frequencies.

6. The directional coupler according to claim 1, further comprising:
a third open-circuited stub, connected to the first transmission line, having a stub length that causes a short circuit in frequency different from frequencies of the first open-circuited stub and the second open-circuited stub; and
a short-circuited stub having a stub length that causes a short circuit in desired frequency, wherein the first transmission line, the first open-circuited stub, the second open-circuited stub, the third open-circuited stub and the short-circuited stub compose the circuit for impedance matching in center frequency with an external circuit.

7. A directional coupler comprising:
a first transmission line through which a radio-frequency signal is transmitted;
a second transmission line in electromagnetic coupling with the first transmission line;
a first short-circuited stub connected to an input side of the first transmission line; and
a second short-circuited stub connected to an output side of the first transmission line,
wherein each of the first short-circuited stub and the second short-circuited stub has a stub length that causes a short circuit in desired frequency, and the first transmission line, the first short-circuited stub and the second short-circuited stub compose a circuit for impedance matching in center frequency with an external circuit.

8. The directional coupler according to claim 7, wherein the first short-circuited stub and the second short-circuited stub cause a short circuit in different frequencies.

9. The directional coupler according to claim 7, further comprising:
an open-circuited stub, connected to the first transmission line, having a stub length that causes a short circuit in desired frequency, wherein the first transmission line, the first short-circuited stub, the second short-circuited stub and the open-circuited stub compose the circuit for impedance matching in center frequency with an external circuit.

10. A radio communication apparatus comprising:
a variable gain amplifier that variably amplifies an input radio-frequency signal;
the directional coupler according to claim 1 that performs impedance matching on the signal output from the variable gain amplifier; and
an automatic power control circuit that controls a gain of the variable gain amplifier so that a transmit output from the directional coupler remains within predetermined limits.

11. A directional coupling method comprising the steps of:
coupling a first transmission line and a second transmission line in electromagnetic coupling;
connecting open-circuited stubs that cause a short circuit in desired frequency to an input side and an output side of the first transmission line to perform impedance matching in center frequency with an external circuit; and
inputting a radio-frequency signal to the first transmission line and the open-circuited stubs.

12. A directional coupling method in which stubs for radio-frequency spurious suppression are disposed at input and output sides of a first transmission line in a directional coupler, and using the stubs with susceptance and the first transmission line, impedance matching in carrier frequency between circuits connected to input and output ports is performed.
